(19) United States
(12) Patent Application Publication
(10) Pub. No.: US 2019/0215423 A1
(43) Pub. Date: Jul. 11, 2019

(54) SECURITY MONITORING SYSTEM

(71) Applicant: TP-Link Research America Corp., San Jose, CA (US)

(72) Inventors: Elliot L. Ortiz, San Francisco, CA (US); Hirotomi Teranishi, San Jose, CA (US); Daniel K. Harden, Palo Alto, CA (US); Mukund Rajukumar, San Jose, CA (US); Cheng Li, Shenzhen (CN); Mingyuan Li, San Jose, CA (US); Wen Kang, Shenzhen (CN); Meera Patel, San Jose, CA (US)

(73) Assignee: TP-Link Research America Corp., San Jose, CA (US)

(21) Appl. No.: 16/296,227

(22) Filed: Mar. 8, 2019

Related U.S. Application Data
(63) Continuation-in-part of application No. 15/864,967, filed on Jan. 8, 2018, now Pat. No. 10,267,454.

(51) Int. Cl. H04N 5/225; H04N 7/18; H04N 5/232

(52) U.S. Cl. CPC H04N 5/2253; H04N 5/23299; H04N 7/183; H04N 5/2252

(57) ABSTRACT

A security monitoring system includes a sensor and a magnetic base. The sensor may include a ferromagnetic convex cover. The magnetic base may include a concave surface. The sensor is configured to be magnetically releasably mounted onto the magnetic base by constructing the convex cover of the sensor to snug with the concave surface of the magnetic base.

### CROSS-REFERENCE TO RELATED APPLICATIONS

This application claims the benefit of U.S. application Ser. No. 29/627,546, filed Nov. 28, 2017. This application claims the benefit of U.S. application Ser. No. 15/864,967, filed Jan. 8, 2018. The entire disclosures of the applications referenced above are incorporated by reference.

### FIELD

The present disclosure relates to a security monitoring system with a mount, and in particular, the system is configured to be continuously adjusted and securely held to any desired angular position.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The technology is related to a security monitoring system including a sensor or security monitoring device (e.g., a portable sensor, a camera, etc.) and a bracket, which system can be positioned for monitoring indoor/outdoor activities. The bracket is easy to use and allows the sensor to be continuously adjusted to various positions to cover a wide range of views of a monitored area.

A monitoring system is often configured to direct a sensor to an area of interest by mounting/attaching the sensor to a bracket. The sensor is usually screwed or bolted to the bracket so that the sensor is tilted and panned at a particular angle. The sensor may be repositioned by unscrewing or prying open the mechanism using a tool. As such, adjusting the position of the sensor can be cumbersome and time-consuming and accurately fine-tuning the sensor is also very challenging. It is very important to have a stable, adjustable mounting bracket that allows a flexible positioning and orientation of the sensor.

### SUMMARY

The present disclosure generally provides a monitoring system having a magnetic bracket that allows easily mounting, positioning, orienting, and adjusting of a sensor. The sensor may be an image sensor or other sensor device. The sensor generally includes a ferromagnetic convex surface configured to be magnetically mounted onto a magnetic bracket having a concave surface. The mounting mechanism provides an instant set-up, extremely stable, and easy to use and allows the sensor(s) to be continuously adjusted to different position to aim at different angles of a monitoring area. In one example, the bracket may include a ring that holds multiple magnets (uniformly) distributed around the ring. When a sensor with a ferromagnetic surface sits on/contacts with the ring, the sensor is held firmly at multiple points by the magnets distributed on the ring. The sensor can be easily adjusted by hand to view/monitor different areas on all four sides (top/bottom/left/right) of the device without the need for any tools to unscrew or pry open anything.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view showing an example security monitoring system including a bracket according to the principles of the present disclosure;

FIG. 2 is a perspective view showing the bracket of FIG. 1 according to the principles of the present disclosure;

FIGS. 3-4 are exploded views of the bracket of FIG. 2 according to the principles of the present disclosure;

FIG. 5 is a perspective view showing an example mounting plate integrated with the bracket of FIG. 2 according to the principles of the present disclosure;

FIG. 6 is an exploded view of the mounting plate integrated with the bracket of FIG. 2 according to the principles of the present disclosure;

FIG. 7 is a perspective view showing an example mounting installation of the example security monitoring system of FIG. 1 according to the principles of the present disclosure;

FIGS. 8-13 are perspective views showing another example security monitoring system including another example bracket according to the principles of the present disclosure;

FIG. 14 is a perspective view showing another example mounting plate integrated with the bracket of FIGS. 8-13 according to the principles of the present disclosure;

FIG. 15 is an exploded view of the mounting plate integrated with the bracket of FIG. 14 according to the principles of the present disclosure;

FIGS. 16-17 are perspective views showing the example mounting base of FIGS. 14-15 according to the principles of the present disclosure;

FIGS. 18A and 18B are perspective views showing the assembled mounting base of FIGS. 14-17 according to the principles of the present disclosure.

FIG. 19 is a perspective view showing an example monitoring device that is configured to be held by a bracket according to the principles of the present disclosure;

FIG. 20 is an enlarged perspective view showing a portion of the example monitoring device of FIG. 19 according to the principles of the present disclosure;

FIG. 21 is a diagram illustrating a field of view of the example monitoring device of FIG. 16 according to the principles of the present disclosure;

FIG. 22 is a perspective view showing another example security monitoring system including an example base and another monitoring device according to the principles of the present disclosure;

FIG. 23 is a perspective view showing the base of FIG. 22 according to the principles of the present disclosure;

FIG. 24 is an exploded view of the base of FIG. 24 according to the principles of the present disclosure;

FIG. 25 is an exploded view of another example base according to the principles of the present disclosure;

FIG. 26 is a perspective view showing the example security monitoring system of FIG. 22, which is configured to be secured to a vertical wall according to the principles of the present disclosure; and

FIGS. 27A-27B are perspective views of the example monitoring device of FIG. 22 according to the principles of the present disclosure.

In the drawings, reference numbers may be reused to identify similar and/or identical elements.

### DETAILED DESCRIPTION

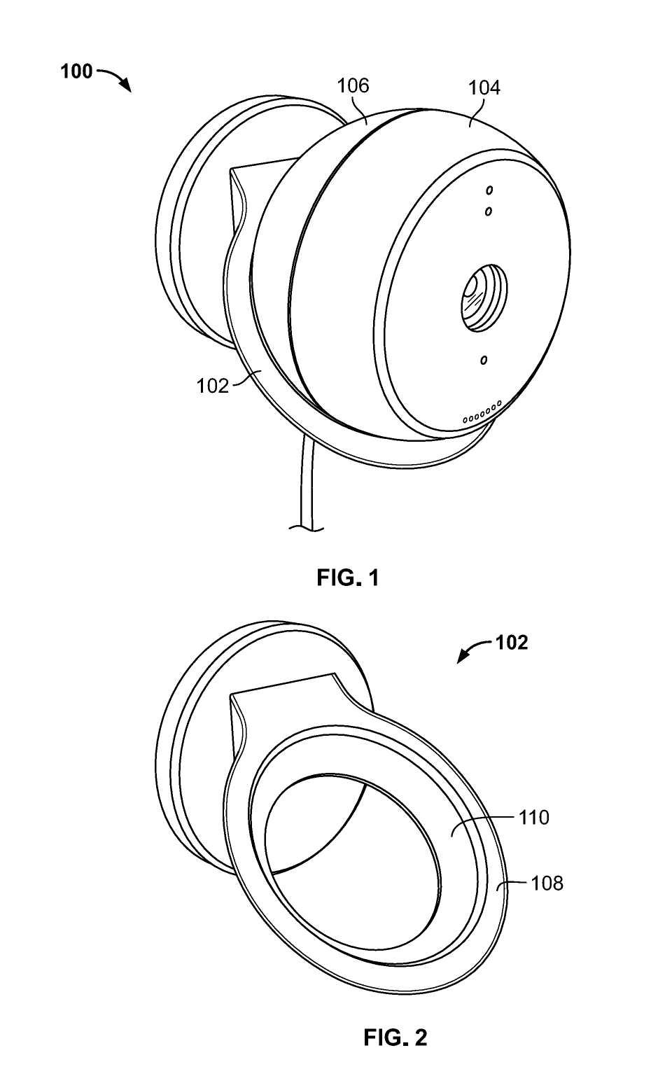

FIG. 1 illustrates an example security monitoring system 100 including a bracket 102 and a sensor 104. The sensor 104 generally includes a ferromagnetic convex cover 106, and the bracket 102 is magnetic and generally has a concave surface shaped and sized to snug with the convex cover 106 and securely hold the sensor 104 by attracting the sensor 104 by magnetic force. Specifically, the surface curvature of the convex cover 106 matches the surface curvature of the concave surface. As such, the sensor 104 can be magnetically releasably mounted onto the bracket 102 and continuously adjusted to various positions in relation to the bracket 102 without any tools.

FIG. 2 illustrates the example bracket 102 of FIG. 1. the bracket 102 may include a crater-shaped ring 108 having the concave surface 110. As shown in FIG. 2, the crater-shaped ring 108 has generally a substantially uniform thickness.

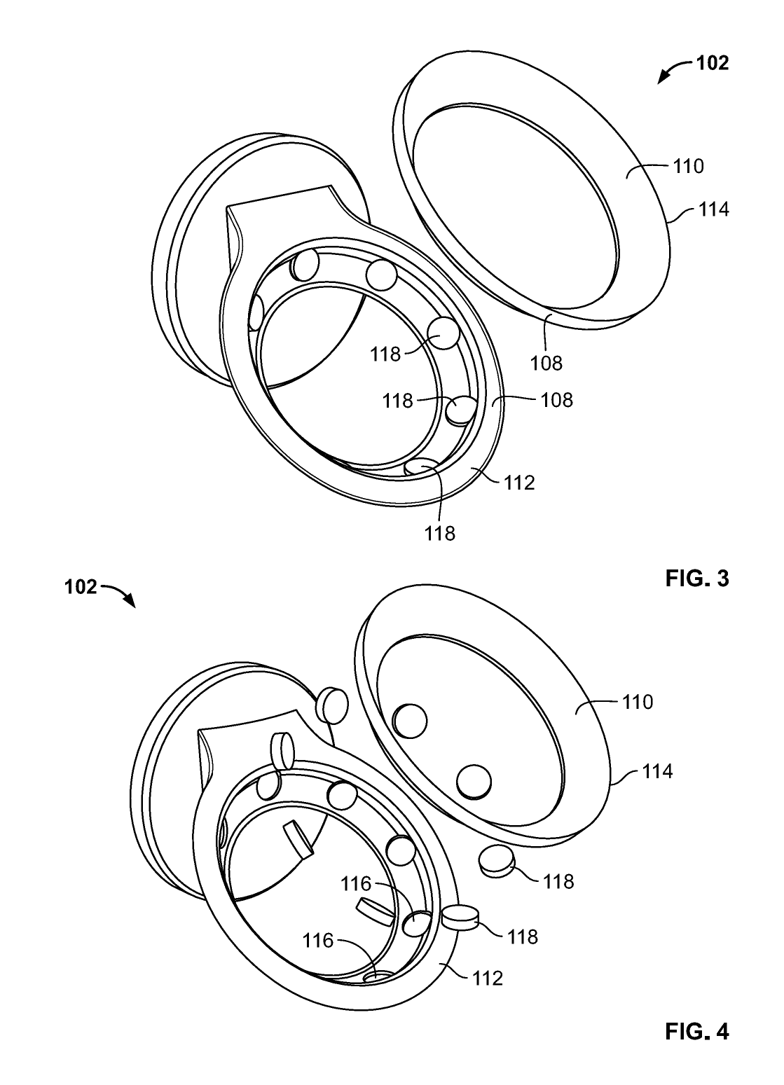

FIGS. 3 and 4 are perspective exploded views of the bracket 102. The bracket 102 is shown disassembled. The crater-shaped ring may include two mating parts, a base ring 112 and a cover ring 114 having the concave surface 110. Multiple slots 116 may be defined on the surface of the base ring 112 to hold multiple magnets 118. In one example, the slots formed substantially equally spaced. As such, the multiple magnets 118 respectively placed in the slots are distributed uniformly along the crater-shaped ring. The magnets can be for example, permanent magnets, electromagnets, or other temporary magnets. The magnets 118 may be glued within the slots 116. Alternatively, the magnets 118 can be fastened to the base ring 112 without the slots 116. The cover ring 114 may be adapted to be snapped on the base ring 112 to cover the magnets 118 to thereby integrally form the crater-shaped ring 108. Multiple magnets 118 are substantially evenly distributed underneath the concave surface 110 to produce strong magnetic attractive forces to firmly pull the ferromagnetic cover 106 of the sensor 104 at multiple points by the magnets when the sensor is positioned on the bracket. Such configuration can allow larger contacting area with the bracket and hold the sensor more securely than the configuration having a centralized attaching contact point/area. The sensor 104 may be continuously repositioned by moving the sensor 104 into a new position respective to the crater-shaped ring 108 to thereby reorient the sensor 104 with a different field of view. Although the example magnets 118 shown in FIGS. 3-4 are button-shaped, the magnets may include other shapes.

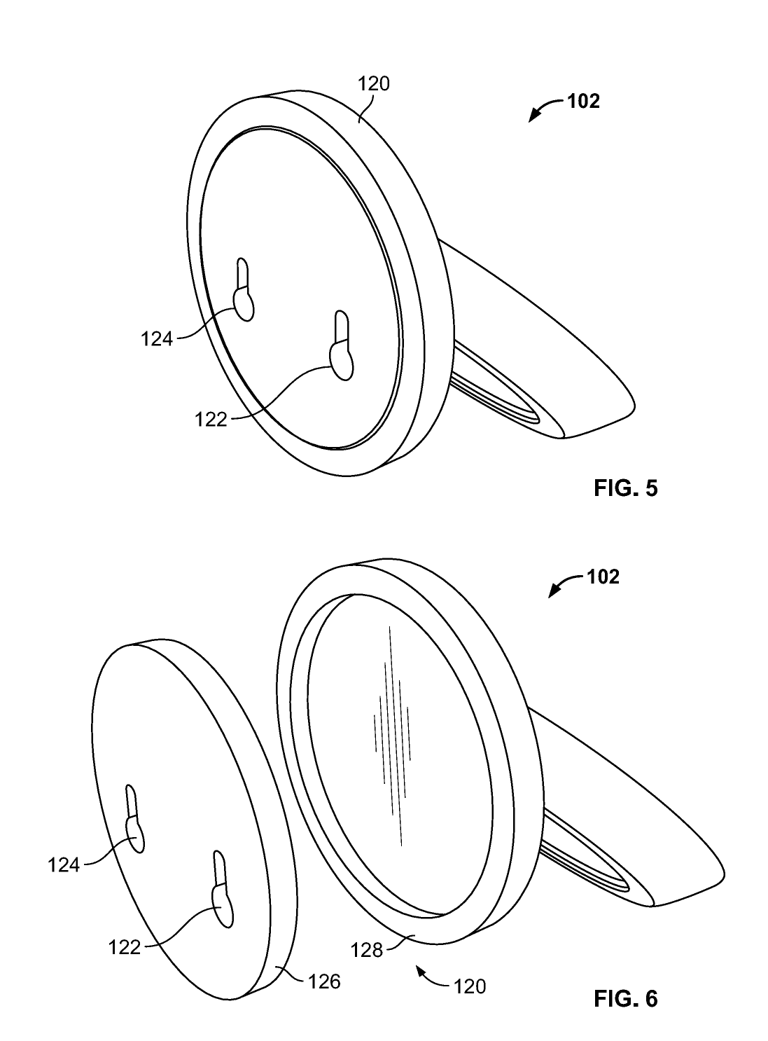

FIG. 5 shows an example mounting plate 120 integrated with the bracket 102. The mounting plate 120 may include mounting fitting structures to be secured to a surface (e.g., a vertical wall, etc.) or similar structure (e.g., a horizontal surface, etc.). As shown in FIG. 5, the mounting plate 120 may include, for example, holes 122, 124 adapted to receive fasteners such as tacks, screws, nails, and wall anchors.

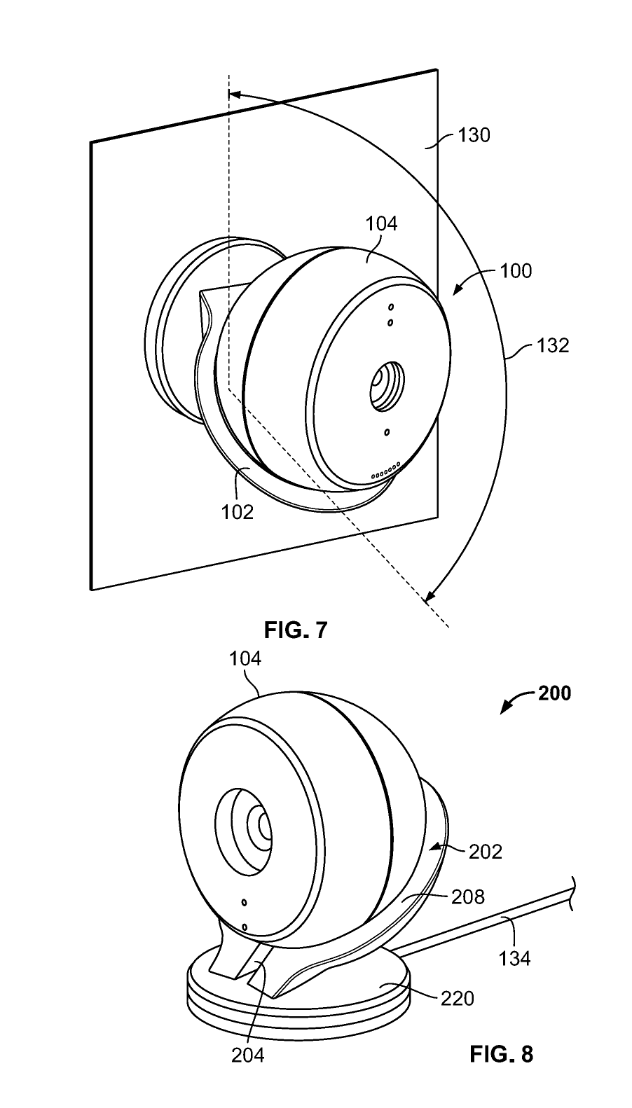

FIG. 6 is a perspective exploded view of the mounting plate 120 integrated with the bracket 102. The mounting plate 120 is shown disassembled with two parts, a mounting base 126 and the mounting cover 128. Such a construction can enable the bracket 102 to have various orientations after the mounting base 126 is secured to the wall or similar surface by snapping/clamping/clasping/attaching the mounting cover 128 to the mounting base 126 at various directions. The example bracket 102 is constructed to have an angle between the mounting plate 120 and the crater-shaped ring 108. As such, when the mounting plate 120 is adapted to be mounted on a surface in various orientations, the sensor 104 can face various directions.

FIG. 7 is a perspective view showing an example installation of mounting the security monitoring system 100 to a wall 130. In the illustrated example mounting position of the bracket 102, the sensor 104 can be rotated to different positions to cover a wide field of view 132.

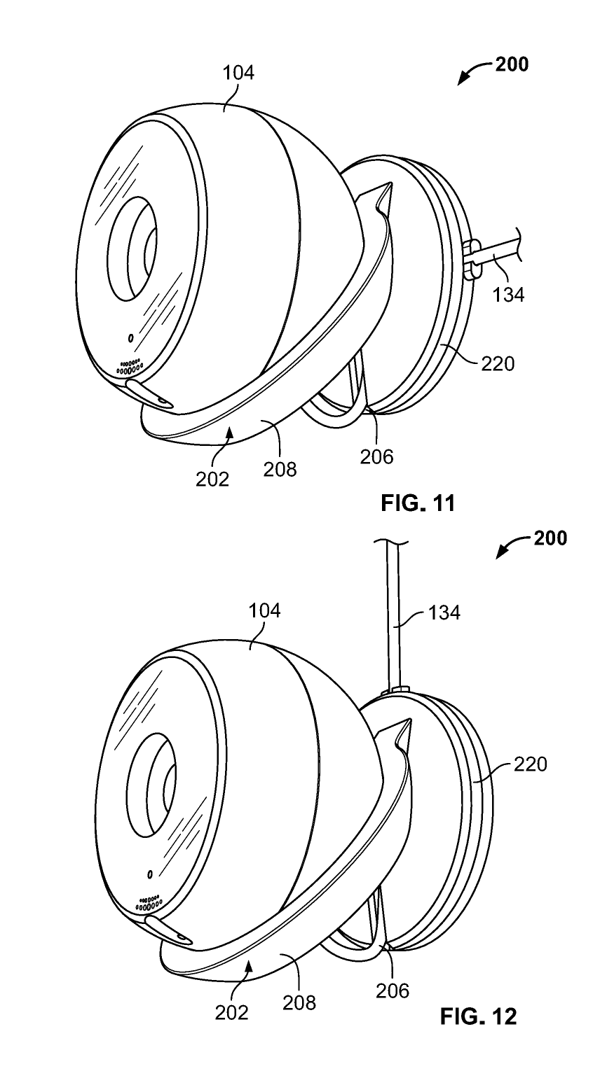

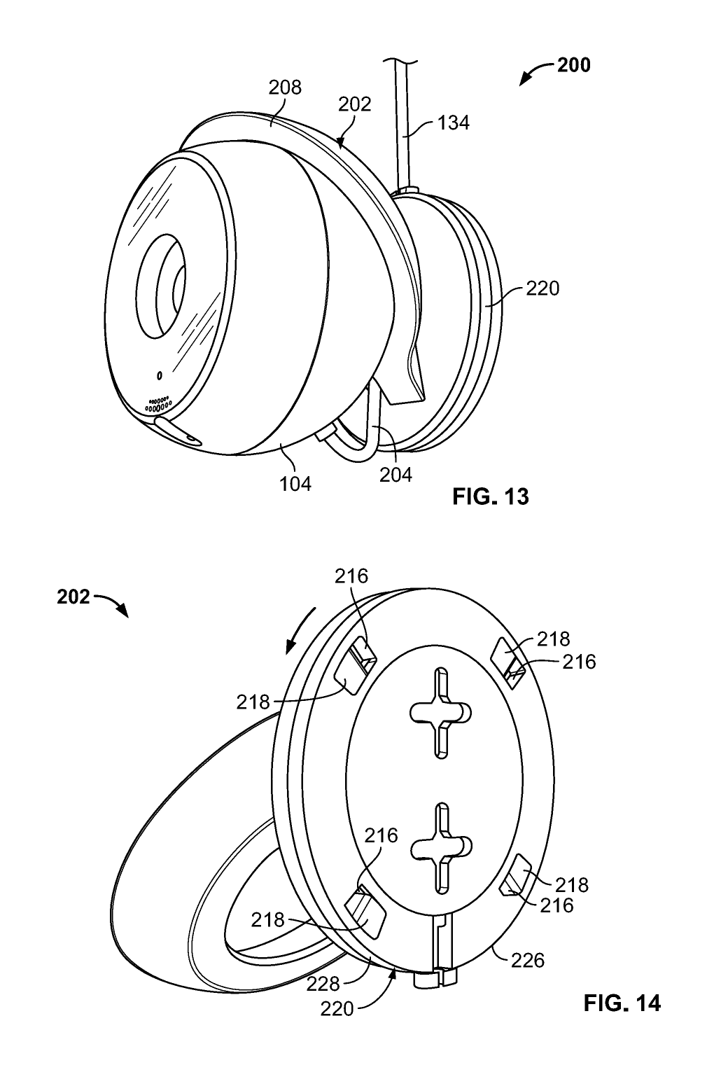

FIGS. 8-13 are perspective views showing another example security monitoring system 200 including another example bracket 202 and the sensor 104. The bracket 202 may include a slot/channel 204 located at the joint between the crater-shaped ring 208 and the mounting plate 220. Additionally, and/or alternatively, the bracket 202 may include a slot/channel 206 defined on the mounting plate 220 generally from the center to the edge of the mounting plate 220. The slots/channels 204 and 206 may be arranged/adapted to retain or guide a cable/wire 134 that is connected to the sensor 104 in different orientations/directions/paths

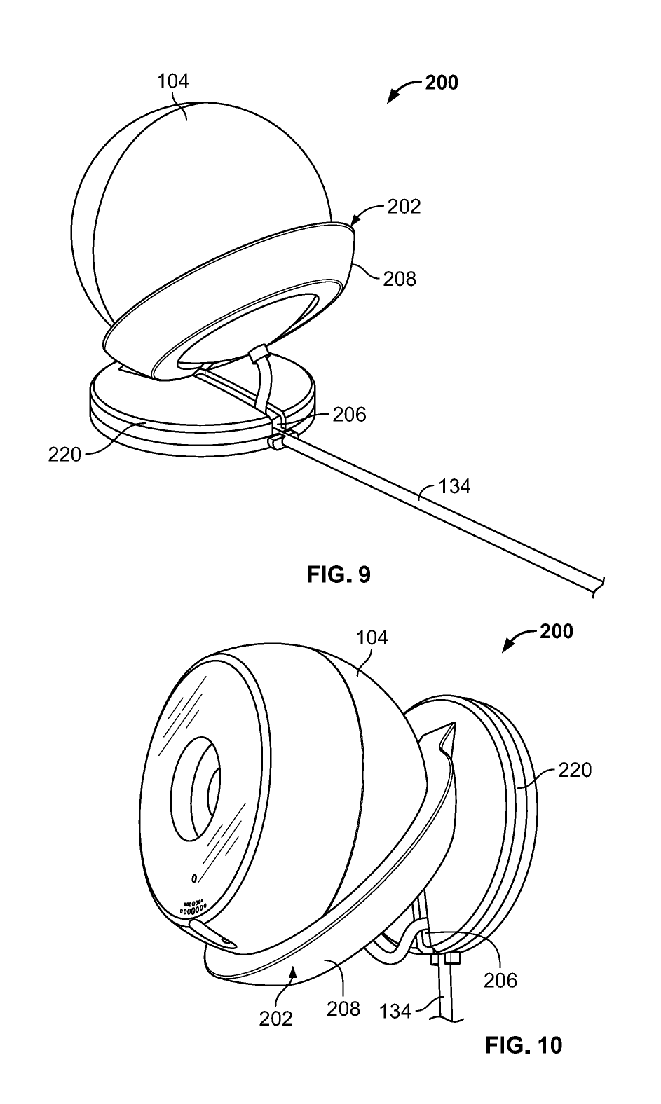

As shown in FIGS. 9-13, the slots/channels 204 and 206 may be arranged aligned to each other or perpendicular to each other. Alternatively, the slots/channels 204 and 206 may be arranged to have different angles to retain/guide the cable/wire 134.

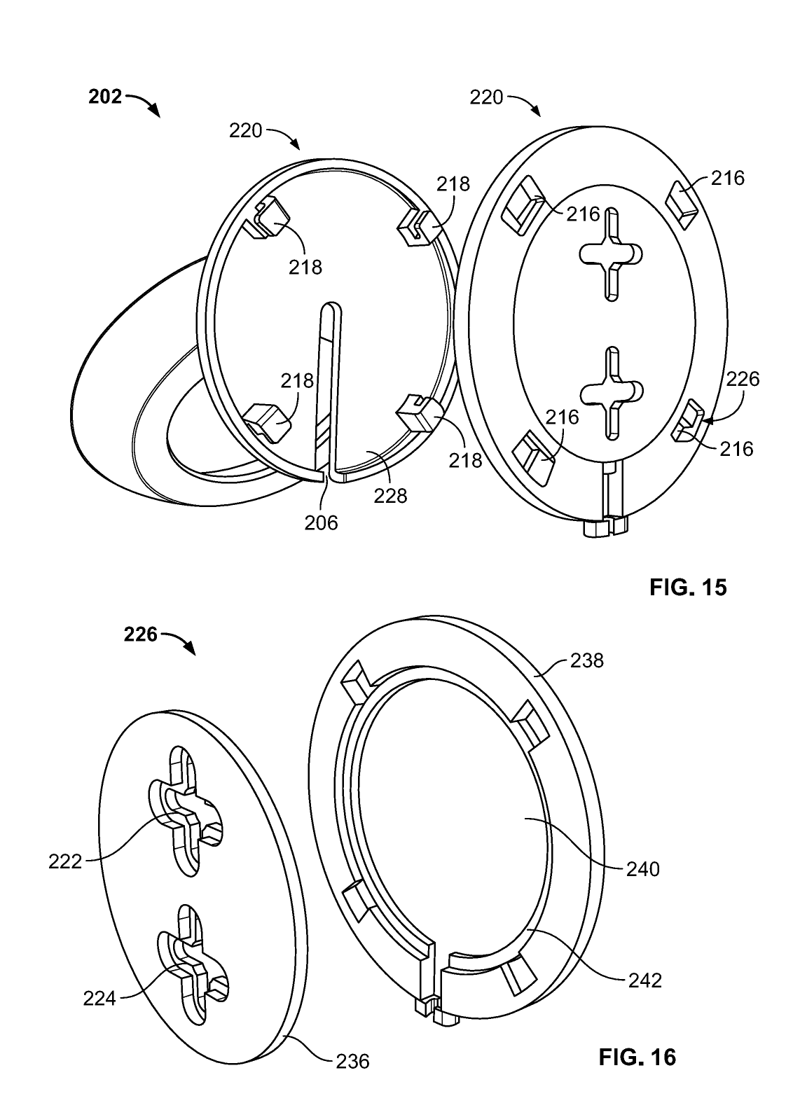

FIG. 14 is a perspective view showing the example mounting plate 220 integrated with the bracket 202. FIG. 15 shows the mounting plate 220 integrated with the bracket 202 disassembled with two parts, a mounting base 226 and a mounting cover 228. As shown in FIGS. 14 and 15, the mounting base 226 may include multiple tab slots 216 and the mounting cover 228 may include multiple tongues 218. For this example, the number of the tab slots 216 and the number of the tongues 218 are the same to form a locking structure. The mounting cover 228 is adapted to respectively insert its tongues 218 into the tab slots 216 and twist to lock. The shown example locking structure may enable four relative positions/orientations of the mounting cover 228 in relation to the mounting base 226 by selectively inserting the tongues 218 into successively various tab slots 216. As such, the relative position of slot/channel 204 in relation to the slot/channel 206 may change to retain/guide the cable/wire 134 in different ways, as shown in FIGS. 8-13. Alternatively, the number of the tab slots 216 of the mounting base 226 and the number of the tongues 218 of the mounting cover 228 can be different numbers to enable different relative positions/orientations of the mounting base 226 and the mounting cover 228 in relation to each other. The number of tab slots 216 can be any multiples of the number of tongues 218.

Similar to the security monitoring system 100, the security monitoring system 200 also allows the bracket 202 to have various orientations after the mounting base 226 is secured to the wall or similar surface by attaching the mounting cover 228 to the mounting base 226 at various directions.

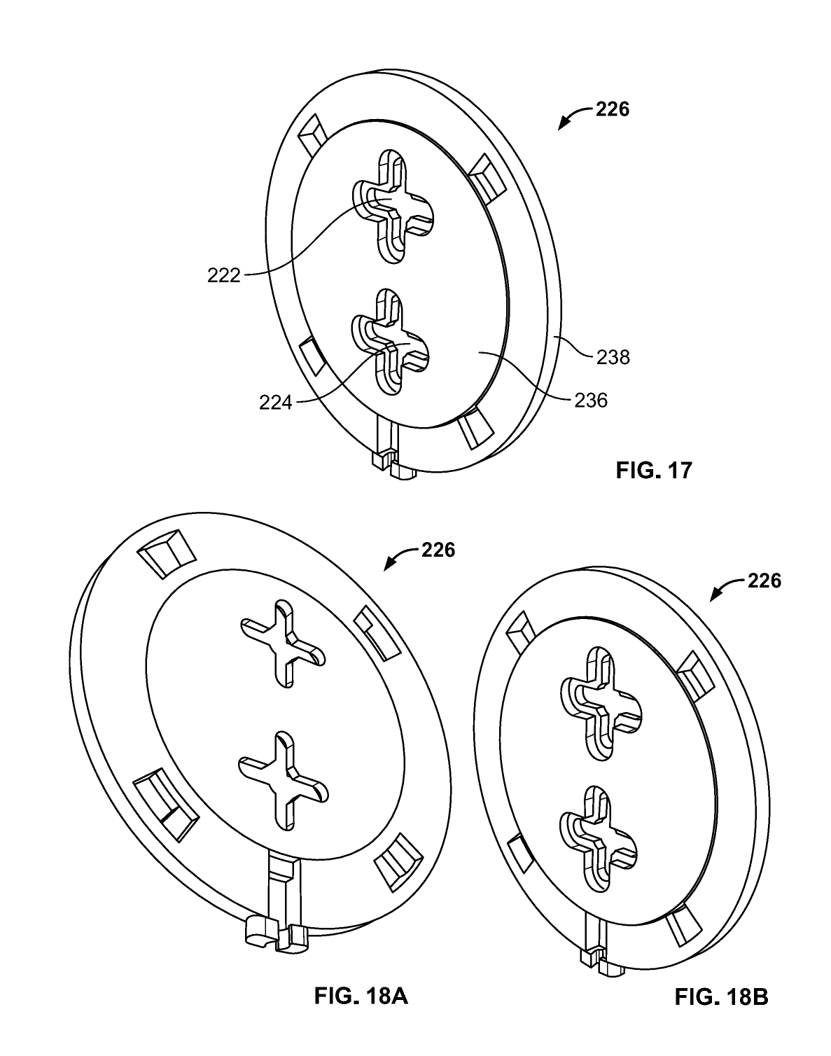

As shown in FIGS. 16-17, the example mounting base 226 may further include a mounting base plate 236 and an orientation ring 238. The orientation ring 238 generally includes an opening 240 with a smaller dimension than that of the mount base plate 236. Additionally, the orientation ring may include a thin shoulder 242 along the edge of the inner opening 240. The mount base plate 236 may include, for example, holes 222, 224 adapted to receive fasteners such as tacks, screws, nails, and wall anchors. As such, the mount base plate 236 can be pressed onto the orientation ring against the wall or similar surface to secure the orientation ring 238.

FIGS. 18A and 18B are perspective views respectively showing the two opposed sides of the assembled mounting base 226. Specifically, FIG. 18A shows the side of the assembled mounting base 226 that is adapted to attach to the wall or similar surface. FIG. 18B shows the opposed side of the assembled mounting base 226 that is adapted to receive the mounting cover 228 in FIG. 15.

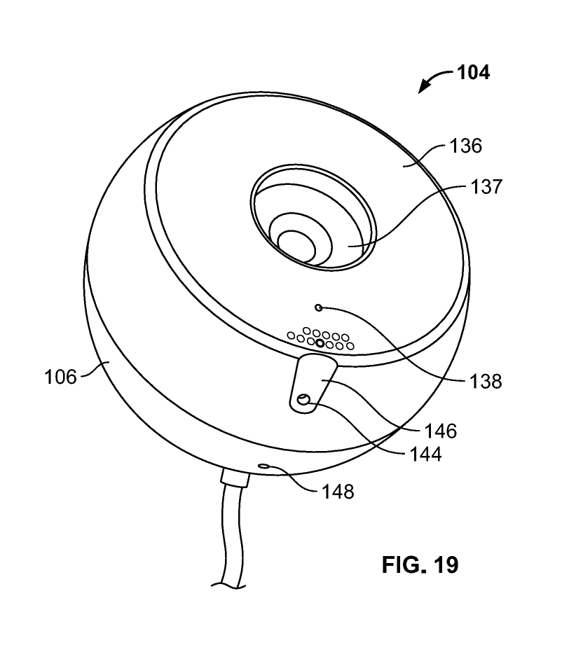

FIG. 19 shows an example monitoring device (e.g., the sensor 104) that is configured to be held/supported by the example bracket 102 or 202. the monitoring device may be, for example, a camera, a video camera, a mobile phone, a personal data assistant (PDA), a web camera, a computer, or the like.

The example monitoring device shown in FIG. 19 is a spherical dome shaped camera 104. The camera 104 may include a generally spherical dome shaped back with a ferromagnetic convex cover 106 and a generally flat surface 136. As previously described, the convex cover 106 may be shaped and sized to be snugged by the concave surface of the bracket 102 or 202. Additionally, the camera 104 may be securely held, or releasably attached/mounted onto or released from the magnetic bracket without any tool. In addition, the generally spherical dome shaped camera can maximize the internal space capacity.

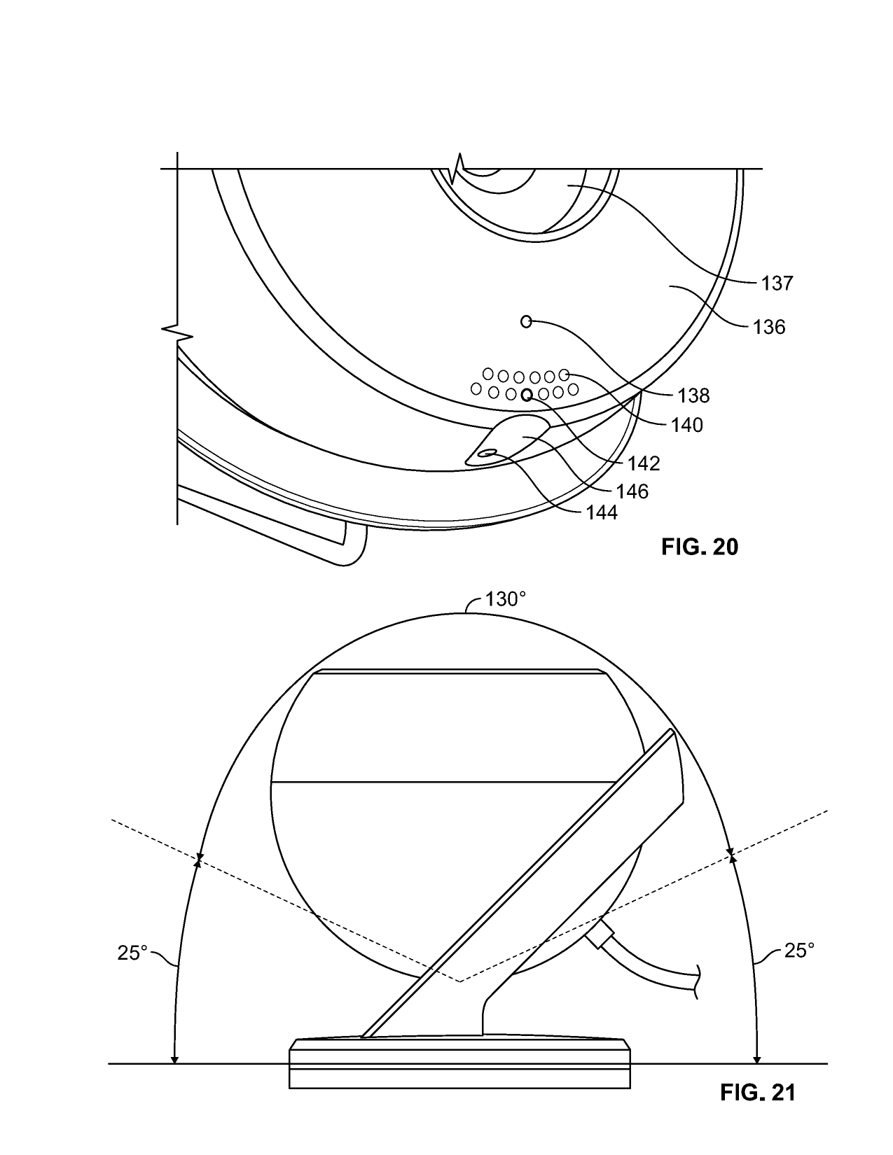

FIG. 20 is an enlarged perspective view showing a portion of the camera 104. As shown in FIGS. 19 and 20, the surface 136 may include a lens 137 to detect visual signals, a light sensor 138 to detect light levels, multiple speaker holes 140, an indicator 142 to indicate the operation status, and a microphone 144 to capture audio signals in the surroundings of the camera 104. The light sensor may be used, for example, to trigger a night vision mode of the camera 104. The speaker holes 140 may be configured for transmit the audio sounds from a user. The indicator 142 may include an LED to indicate the operation status. For example, blinking red indicates that the camera 104 has failed to connect to the network; green indicates that the camera 104 is online connected to the network, blinking amber and green may indicate that the camera 104 is setup mode and is not currently connected to any network;

As shown in FIGS. 19 and/or 20, the camera 104 may further include a microphone 144 on the surface of the camera 104 and a recess 146 defined in the vicinity of the microphone 144. When the portion surface having the microphone 144 is positioned to face the crater-shaped ring 108 or 208, the recess 146 may keep the crater-shaped ring 108 or 208 from blocking the microphone 144. Furthermore, the camera 104 may further include a reset button inside a hole 148. The reset button can be pressed for a period of time (e.g., 5s) by inserting a needle into the hole 148 to factory reset the camera 104 (e.g., putting the camera in pairing mode, resolving the issue of connecting the camera 104 to the network, etc.).

FIG. 21 is a diagram illustrating an example field of view of the camera 104. This example camera is configured to generally have a field of view of about 130 degrees. However, the camera can be configured to have a field of view that is more or less than 130 degrees. The mounting mechanism described in the present disclosure enables the camera 104 to rotate about the bracket 102 or 202 to various angular positions to cover about 180 degrees horizontally and vertically by repositioning the camera 104 held by the bracket 102/202 without using any tools to unscrew or pry open anything. In addition, the capability of continuously adjusting the position of the camera 104 in relation to the bracket can allow the camera 104 to aim at any direction.

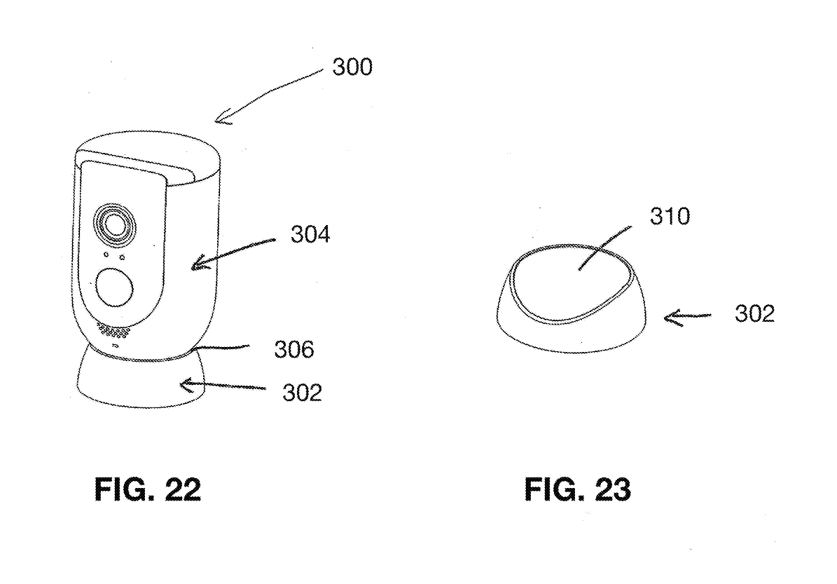

FIG. 22 illustrates another example security monitoring system 300 including a base 302 and a sensor 304. Similar to the security monitoring system 100, the sensor 304 generally includes a ferromagnetic convex cover 306, and the base 302 is magnetic and generally has a concave surface shaped and sized to snug with the convex cover 306 and securely hold the sensor 304 by attracting the sensor 304 by magnetic forces. Specifically, the surface curvature of the convex cover 306 matches the surface curvature of the concave surface. As such, the sensor 304 can be magnetically releasably mounted onto the base 302 and continuously adjusted to various positions in relation to the base 302 without any tools. The sensor 304 may be continuously repositioned by moving the sensor 304 into a new position in respect of the crater-shaped base 302 to thereby reorient the sensor 304 with a different field of view. The sensor 304 is enabled to rotate about the base 302 to various angular positions to cover a wide angle horizontally and vertically.

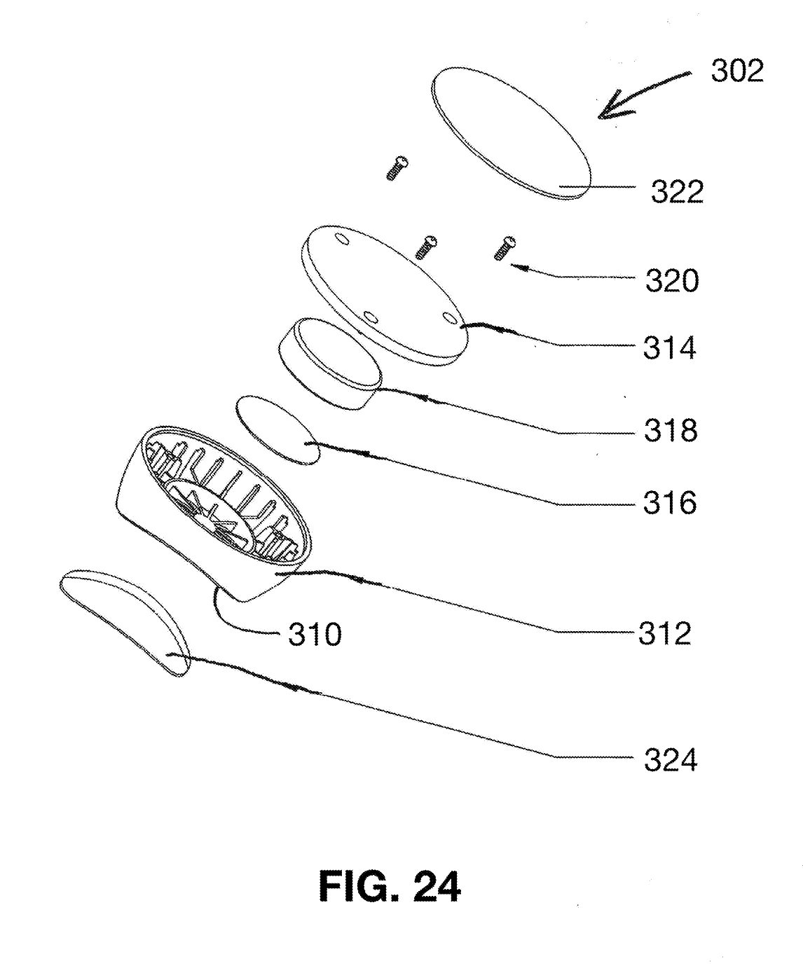

FIG. 23 illustrates the example base 302 of FIG. 22. The base 302 may be a crater-shaped base having a concave surface 310. As shown in FIG. 24, the concave surface 310 has generally smooth surface shaped and sized to snug with the convex cover 306 and securely hold/attract the sensor 304 by magnetic forces.

FIG. 24 is an exploded view of the base 302. The base 302 is shown disassembled. The crater-shaped base 302 may include a container 312 and a cover 314 that encloses a magnet block 318. The container 312 may include the concave surface 310 together with the generally flat cover 314 to enclose a hollow central cavity. A piece of foam 316 may be placed within the container 312 and in contact with the magnet block 318 to provide cushioning properties and to prevent the magnet block 318 from vibrating. The magnet block 318 can be for example, a permanent magnet, an electromagnet, or other temporary magnets, etc. The cover 314 may be fastened to the container 312 using fasteners 320 (e.g., bolts, screws, studs, etc.). The magnet 318 may be placed/secured (e.g., glued, attached, etc.) within the container 312. Additionally, a first rubber pad 322 may be attached/glued/molded to the cover 314 and a second rubber pad 324 may be attached/glued/molded to the concave surface 310 to provide non-slip surfaces. The configuration with the larger size of the magnetic block/bar can provide stronger magnetic force to contact/hold the sensor more securely. Although the example magnet 318 shown in FIG. 24 has a cylindrical shape, the magnet 318 may include other shapes.

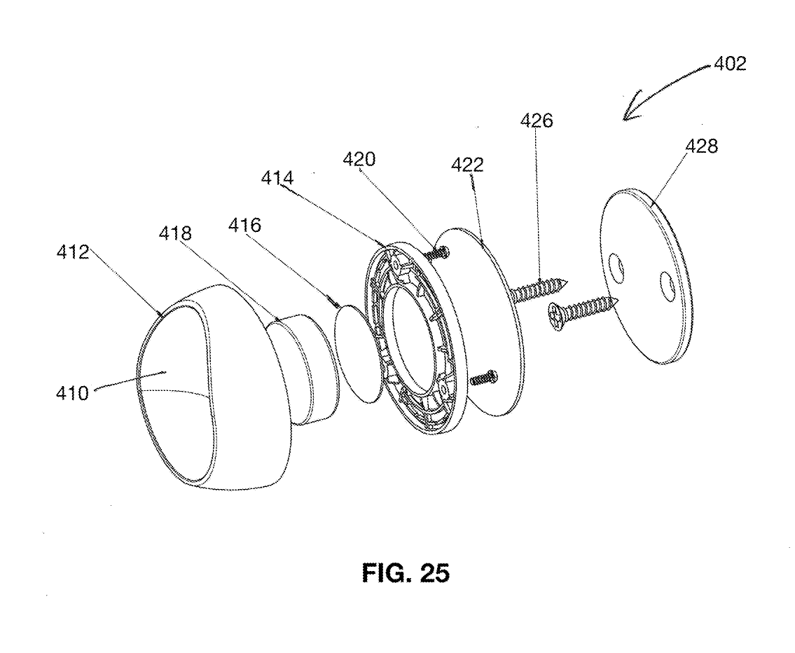

FIG. 25 shows another example base 402. The base 402 is shown disassembled into following parts, a housing 412 and a cover 414 that encloses a magnet block 418, a piece of foam 416 placed within the housing 412 and in contact with the magnet block 418 to provide cushioning properties and prevent the magnet block 418 from vibrating. The housing 412 may further include a concave surface 410 and a hollow central cavity. The magnet block 418 can be for example, a permanent magnet, an electromagnet, or other temporary magnets, etc. The magnet 418 may be placed/secured (e.g., attached, glued, etc.) within the housing 412. Additionally, fasteners 420 (e.g., bolts, screws, studs, etc.) may be used to secure a rubber pad 422 to the cover 414. The rubber pad 422 provides a non-slip surface. Further, the base 402 may include a mounting structure having a mounting plate 428 configured to secure the base 402 to a wall or a similar surface with fasteners 420 (e.g., bolts, screws, studs, etc.). Similar to the example base 302, the configuration with the larger size of the magnetic block/bar can provide stronger magnetic force to contact/hold the sensor more securely. The sensor 304 may be continuously repositioned by moving the sensor 304 into a new position in respect of the crater-shaped base 402 to thereby reorient the sensor 304 with a different field of view. Although the example magnet 418 shown in FIG. 25 has a cylindrical shape, the magnet 418 may include other shapes.

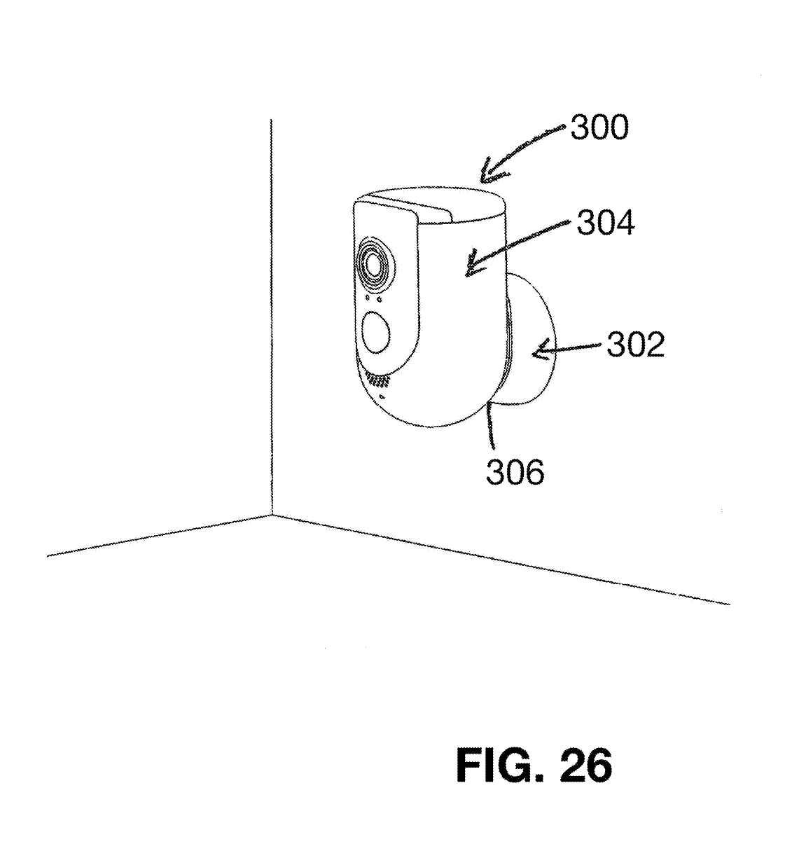

As shown by FIG. 26, the base 302 may be mounted/secured to a wall or a similar surface having a ferromagnetic surface. Alternatively, the base may include a mounting structure for snapping/clamping/clasping/attaching the base to the wall or the similar surface. FIG. 25 illustrates that the base 402 includes one example mounting structure. The sensor 304 can be magnetically releasably mounted onto the bracket 302 and may be adapted/adjusted to have various orientations to enable the sensor 304 to face various directions.

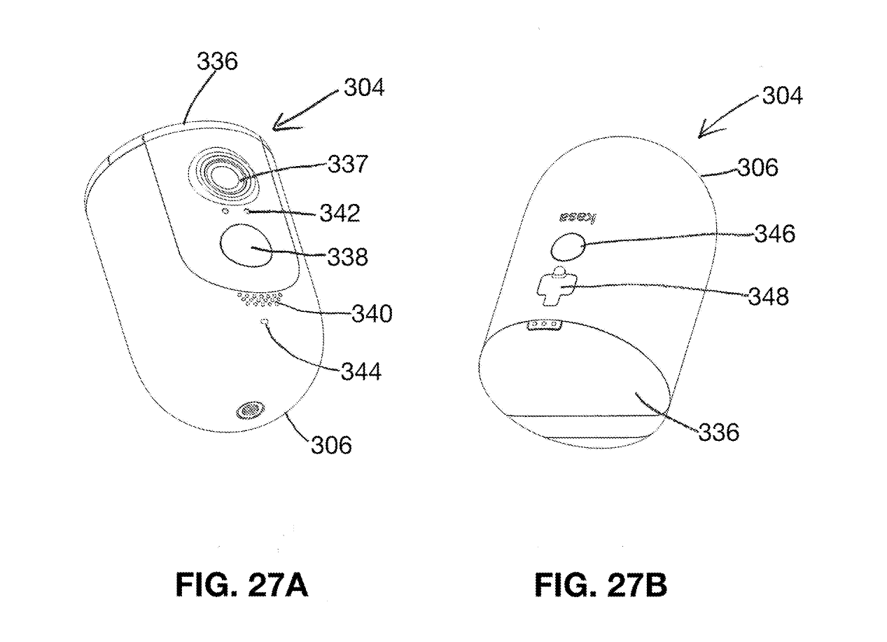

The example monitoring device shown in FIGS. 27A-27B is a spherical dome shaped wireless camera 304. The camera 304 may include a generally spherical end 306 and a flat end 336. The spherical end 306 having a ferromagnetic surface shaped and sized to be snugged by the concave surface of the base 302 or 402. Additionally, the camera 304 may be securely held, or releasably attached/mounted onto or released from the magnetic bracket without any tool. In addition, the generally spherical dome shaped camera can maximize the internal space for holding one or more rechargeable batteries.

FIG. 27A shows that the camera 304 may include a lens 337 to detect visual signals, a passive infrared sensor (PIR sensor) 338 to detect motion of people, animals, or other objects, multiple speaker holes 340, an indicator 342 to indicate the operation status, and a microphone 344 to capture audio signals in the surroundings of the camera 304. The speaker holes 340 may be configured for transmitting the sounds from a user. The indicators 342 may include at least one LED to indicate the operation status. For example, alternating amber and green may indicate that the camera 304 is powering on or starting-up, flashing green may indicate that the camera 304 is connecting to the network (i.e., discovery mode), solid green may indicate that the camera 304 is connected to hub, quickly flashing red indicates that the camera 304 has failed to connect to the network or sync with hub, flashing red once per minute indicates low battery (below 15%), quickly flashing amber may indicate that the camera 304 is updating firmware (e.g., flashing amber once per second may indicate factory resetting, etc.), solid amber may indicate that the camera 304 has no connection and is initializing/rebooting, sold blue may indicate that the battery of the camera 304 starts charging, off indicates that the camera 304 may not have power.

As shown in FIG. 27B, the camera 304 may further include a switch 346 and a USB port 348. The switch 346 can be pressed for a period of time (e.g., 1 s) during discovery mode to sync the camera 304 with the hub. Further the switch 346 can be pressed for a longer period of time (e.g., 15 s) to reset the camera 304 to factory settings (e.g., putting the camera in pairing mode, resolving the issue of connecting the camera 104 to the network, etc.). The USB port 348 can be used for charging the battery of the camera 304.

In the drawings, reference numbers may be reused to identify similar and/or identical elements.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

1. A security monitoring system comprising:
a sensor having a spherical dome shape with a spherical end and a flat end, the sensor including a ferromagnetic convex cover on the spherical end;
a base having a crater shape with a concave surface shaped and sized to snug with the ferromagnetic convex cover, the base including a container and a cover that enclose a housing; and
a magnet block positioned within the housing of the base,
wherein the sensor is configured to be magnetically releasably mounted onto the base.

2. The security monitoring system of claim 1, wherein the surface curvature of the ferromagnetic convex cover matches the surface curvature of the concave surface.

3. The security monitoring system of claim 1, wherein the magnetic block includes a cylindrical shape.

4. The security monitoring system of claim 1, further comprising a piece of foam placed within he housing and in contact with the magnet block to provide a cushioning property and prevent the magnet block from shaking.

5. The security monitoring system of claim 1, further comprising at least one rubber pad attached to a flat surface of the base to provide a non-slip surface.

6. The security monitoring system of claim 1, wherein the base further comprises a mounting structure configured to be affixed to a vertical wall or a horizontal surface at various orientations.

7. The security monitoring system of claim 1, wherein the sensor is a camera.

8. The security monitoring system of claim 7, wherein the camera is a spherical dome-shaped wireless camera.

9. The security monitoring system of claim 8, wherein the camera further comprises an LED indicator configured for indicating operation status of the camera.

10. The security monitoring system of claim 8, wherein the spherical dome shaped camera is configured to hold at least one rechargeable battery to provide power for the camera.

11. The security monitoring system of claim 7, wherein the camera is enabled to be continuously repositioned by being rotated about the base to thereby be reoriented with a different field of view.

12. A base for magnetically attract and releasably attach a security monitoring device having a ferromagnetic convex cover, the base comprising:
a crater shape with a concave surface shaped and sized to snug with the ferromagnetic convex cover, the base including a container and a cover that enclose a housing; and
a magnet block positioned within the housing of the base.

13. The base of claim 12, wherein the surface curvature of the ferromagnetic convex cover matches the surface curvature of the concave surface.

14. The base of claim 12, wherein the magnetic block includes a cylindrical shape.

15. The base of claim 12, further comprising a piece of foam placed within he housing and in contact with the magnet block to provide a cushioning property and prevent the magnet block from shaking.

16. The base of claim 12, further comprising at least one rubber pad attached to a flat surface of the base to provide a non-slip surface.

17. The base of claim 12, wherein the base further comprises a mounting structure configured to be affixed to a vertical wall or a horizontal surface at various orientations.

18. The base of claim 12, the magnet block is a permanent magnet, an electromagnet, or a temporary magnet.

19. A method of magnetically attracting and releasably attaching a security monitoring device having a ferromagnetic convex cover, the method comprising:
providing a bracket including (1) a crater-shaped plate-like ring having a crater-shaped plate-like base ring and (2) a crater-shaped plate-like cover ring with a concave surface;
snugging the crater-shaped plate-like cover with the ferromagnetic convex cover of the security monitoring device by matching the surface curvature of the concave surface and the surface curvature of the ferromagnetic convex cover; and
distributing a plurality of button-shaped magnets substantially uniformly between the crater-shaped plate-like base ring and the crater-shaped plate-like cover ring to therefore firmly attract the ferromagnetic convex cover of the security monitoring device at a plurality of points by the plurality of button-shaped magnets when the security monitoring device is positioned on the crater-shaped plate.

20. The method of claim 19, further comprising:
mounting the bracket to a vertical wall or a horizontal surface at various orientations to thereby enable the security monitoring device to face various directions.
